(19) United States
(12) Patent Application Publication
(10) Pub. No.: US 2022/0318647 A1
(43) Pub. Date: Oct. 6, 2022

(54) SINGLE FRAMEWORK FOR BOTH STREAMING AND ON-DEMAND INFERENCE

(71) Applicant: salesforce.com, inc., San Francisco, CA (US)

(72) Inventors: Seyedshahin Ashrafzadeh, Foster City, CA (US); Yuliya Feldman, Campbell, CA (US); Manoj Agarwal, Cupertino, CA (US); Chirag Rajan, Burlingame, CA (US); Swaminathan Sundaramurthy, Los Altos, CA (US); Endri Deliu, San Francisco, CA (US)

(73) Assignee: salesforce.com, inc., San Francisco, CA (US)

(21) Appl. No.: 17/217,406

(22) Filed: Mar. 30, 2021

(51) Int. Cl. G06N 5/04; H04N 21/25; G06N 20/00

(52) U.S. Cl. CPC G06N 5/04; H04N 21/251; G06N 20/00

(57) ABSTRACT

A method and system for a single framework for both streaming and on-demand inference that includes receiving a request from a tenant application for a machine-learning serving infrastructure, where the request identifies features of tenant data and a machine-learning model, subscribing to events for the identified features, initiating the machine-learning model for the request, and generating a prediction using the machine-learning model on the identified features.

### TECHNICAL FIELD

One or more implementations relate to the field of machine learning; and more specifically, to a method for a framework for supporting both streaming and on-demand inference in machine learning systems.

### BACKGROUND ART

Containers are a logical packaging in which applications can execute that is abstracted from the underlying execution environment (e.g., the underlying operating system and hardware). Applications that are containerized can be quickly deployed to many target environments including data centers, cloud architectures, or individual workstations. The containerized applications do not have to be adapted to execute in these different execution environments as long as the execution environment support containerization. The logical packaging includes a library and similar dependencies that the containerized application needs to execute.

However, containers do not include the virtualization of the hardware of an operating system. The execution environments that support containers include an operating system kernel that enables the existence of multiple isolated user-space instances. Each of these instances is a container. Containers can also be referred to as partitions, virtualization engines, virtual kernels, jails, or similar terms.

Machine learning is a type of artificial intelligence that involves algorithms that build a model based on sample data. This sample data is referred to as training data. The trained models can generate predictions, a process also referred to as scoring, based on new data that is evaluated by or input into the model. In this way, machine learning models can be developed for use in many applications without having to be explicitly programmed for these uses.

Containers can be used in connection with machine-learning serving infrastructure. Machine-learning serving infrastructures enable the execution of machine-learning models and provide services to the machine-learning models. Each machine-learning model can be separately containerized with all its required dependencies.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 is a diagram of one embodiment of a machine-learning serving infrastructure that supports a multi-tenant system.

FIG. 2 is a diagram of the streaming manager according to some example implementations.

FIG. 3 is a flowchart of one embodiment of a process for a streaming manager according to some implementations.

FIG. 4 is a diagram of a process for generating update requests based on event subscriptions according to some implementations.

FIG. 5A is a block diagram illustrating an electronic device according to some example implementations.

FIG. 5B is a block diagram of a deployment environment according to some example implementations.

### DETAILED DESCRIPTION

The following description describes implementations for a method and system for handling both on-demand and streaming-based requests for machine learning services, in particular for scoring requests. The implementations can provide a mechanism for supporting streaming requests via an interface for on-demand requests for scoring.

As used herein, an application can be any program or software to perform a set of tasks or operations. A ‘set,’ as used herein includes any positive whole number of items including a single item. A machine-learning model can be a set of algorithms and statistical data structures that can be trained to perform a specific task by identifying patterns and employing inference instead of using explicit instructions. The machine-learning model can be trained for the task using a set of training data.

Machine-learning infrastructure can be automated and organized to support multi-tenancy where containers can be used to execute machine-learning models that can service the applications and users of tenants in a multi-tenant system. Within a multitenant system, a software application is designed to provide each tenant with a tenant-specific view of the application including access only to tenant-specific data, configuration, user management, and similar tenant properties and functionality. A tenant can be a group of users who are part of a common organization or share common access privileges to the multi-tenant system and the associated software applications.

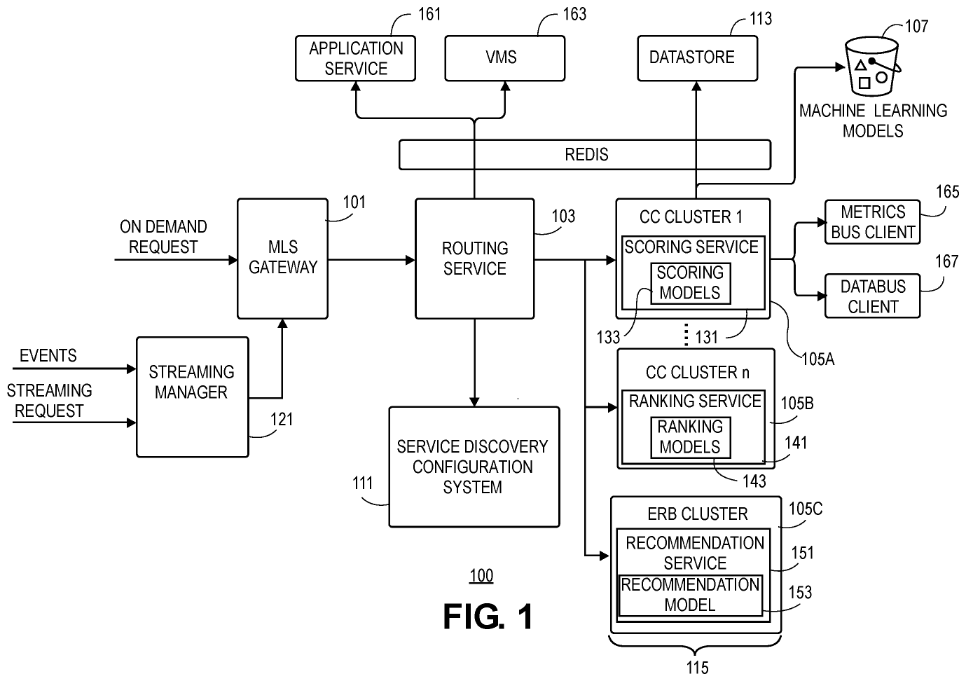

FIG. 1 is a diagram of one embodiment of a machine-learning serving infrastructure that supports a multi-tenant system. The machine-learning serving infrastructure 100 includes a machine-learning service (MLS) gateway 101, routing service 103, set of serving containers 115, and data stores 107, 113, along with other supporting infrastructure.

A serving container (e.g., 105A-C) can be an isolated execution environment that is enabled by an underlying operating system, and which executes the main functionality of a program such as a machine-learning model. A serving container 115 can host any number of machine-learning models for any number of tenants. Serving containers 115 can be organized as a cluster. The cluster can be a group of similar entities, such that a cluster of serving containers can be a group of serving container instances or similar grouping. A machine-learning infrastructure 100 can host any number of serving containers 115 or clusters of serving containers. Different clusters can host different versions or types of machine-learning models.

In some embodiments, a cluster of serving containers 115 can host all machine-learning models of the same version for all tenants. This organization of the cluster can be limited by the number of machine-learning models that a single-serving container can hold. The machine-learning serving infrastructure 100 can scale to accommodate further additions of machine-learning models even in cases where the number or variety of machine-learning models exceed the capacity of the serving containers 115 in the cluster. Since each machine-learning model's size, which can range from hundreds of kilobytes (KB) to hundreds of megabytes (MB), initialization time, and the number of requests that are serviced, can vary widely based on each tenant's underlying database and usage, some clusters of serving containers 115 may have a high resource usage, while other clusters of serving containers 115 may have a low resource utilization. The resource usage, failure, or addition of any server container in a cluster of serving containers can create the need to rebalance the supporting resources in the clusters of serving containers. When changes in the number or resource usage of the serving containers 115 are implemented, then the routing service 103 can manage the load balancing and routing of requests according to the changes in the organization of the serving containers.

A routing service 103 can be implemented as a set of routing containers, or cluster of routing containers, each implementing instances of the routing service 103 functions or subsets of these functions. The routing service 103 can authenticate any request from any tenant, and then route the request for service by machine-learning models to any serving container 115 in a cluster of serving containers.

The machine-learning serving infrastructure receives requests from tenants via a machine-learning service (MLS) gateway 101 or a similar interface. The MLS gateway 101 or similar interface receives a request from a tenant application and identifies a version or instance of a machine-learning model associated with the request. The MLS gateway 101 or similar interface identifies model information associated with machine-learning models corresponding to a cluster of available serving containers associated with the version of the machine-learning model. The MLS gateway 101 uses the model information to select a serving container from the cluster of available serving containers. If the machine-learning model is not loaded in the serving container, the machine-learning service 100 loads the machine-learning model in the serving container. If the machine-learning model is loaded in the serving container, the system executes, in the serving container, the machine-learning model on behalf of the request. The machine-learning infrastructure 100 responds to the request based on executing the machine-learning model on behalf of the request.

A machine-learning serving infrastructure receives a request for scoring a business opportunity from a Customer Relationship Management (CRM) application and identifies the request requires executing a version of an opportunity scoring machine-learning model. The routing service 103 identifies machine-learning model information including memory and CPU requirements for the scoring machine learning models in the cluster of scoring serving containers. The routings service 103 utilizes a load balancing algorithm, resource management algorithm (e.g., a multi-dimensional bin-packing algorithm) to the model information to select the serving container 115 that has the best combination of available resources to execute a copy of the specific machine-learning model associated with an incoming request.

If a copy of the specific machine-learning model is not already loaded in the serving container, then the serving container loads the machine-learning model. When a copy of the specific machine-learning model is verified to be loaded in the serving container, then the specific machine-learning model executes the requested service or function in the serving container. A score or similar prediction is thereby generated and the machine-learning serving infrastructure responds to the request with the score via the MLS gateway 101.

However, this method of operation is primarily related to serving on-demand requests from tenant applications in the multi-tenant system by the machine-learning serving infrastructure 100. The on-demand requests are responsive to specific application functions, or user interactions that generate the requests for scoring from the machine-learning serving infrastructure 100. This method is not directly applicable to the handling of streaming requests. A streaming request can be a request for scoring responsive to events or criteria triggered by a request rather than a direct user or application function. For example, scoring may be requested to be updated when underlying records have changed. If the scoring request is related to business opportunities in a CRM application, then the initial streaming request can be associated with a set of records or data fields upon which the scoring is derived. In this example, if the scoring is related to business opportunities related to large contracts or specific business types, then an initial streaming scoring request can generate a score in the same manner as an on-demand request.

However, the streaming scoring request can be updated or re-executed responsive to changes in the relevant records (e.g., changes in business opportunities records). The streaming scoring request can either directly identify relevant records or types of records or these records can be derived by database associations with the associated machine-learning model. The scoring can be automatically updated when changes occur to the associated records or after a threshold amount of changes or degree of changes have been observed. These scoring updates can be responsive to events from an event management system that provides notifications of changes to relevant records. Records are used herein to refer to any database storage of related data fields in the form of objects, or other structures dependent on the form of the database.

The implementations provide a streaming manager 121 to facilitate the handling of streaming requests. The streaming manager 121 can subscribe or monitor events related to streaming requests received from users, tenant applications, and similar sources. The streaming manager 121 generates on-demand requests to obtain an updated scoring responsive to criteria linked to the monitored events. The requests can be sent to the MLS gateway 101 or a similar interface of the machine-learning infrastructure 100. Scoring results are returned to the requesting user, tenant application, or similar source in the multi-tenant system.

The machine-learning serving infrastructure 100 can be implemented in a cloud computing environment in which data, applications, services, and other resources are stored and delivered through shared data centers. The machine-learning serving infrastructure 100 can be implemented via any other type of distributed computer network environment in which a set of servers control the storage and distribution of resources and services for different client users.

The clusters 105A-C of the example implementation of the machine-learning serving infrastructure 100 can be two of any number of clusters that are serving containers for scoring services 131. Where a scoring service 131 can be a serving container for any number of machine-learning models that perform scoring, i.e., scoring models 133. Each cluster 105A-C can execute different sets of scoring services (e.g., different serving containers) for executing different varieties of machine-learning models (e.g., scoring models 133). An incoming request can be serviced by a single machine-learning model of a single cluster (e.g., a scoring model 133 of a given scoring service 131) or the incoming request can be sub-divided to be serviced by multiple dusters and machine-learning models. In some implementations, the dusters 105A-C and serving containers operate other similar types of machine learning models other than scoring machine-learning models such as ranking and recommendation models. Scoring is provided as an example rather than by limitation. The clusters 115 can include in some implementations ranking services 141 and recommendation services 151, which support ranking models 143 and recommendation models 153, respectively.

In some implementations, the routing service 103 can split the incoming request into separate sub-requests, and then route the sub-requests to their corresponding clusters 105A-C of serving containers. Although these examples describe the clusters 115 of serving containers that serve one version of the scoring type of machine-learning models, one version of the recommending type of machine-learning models, and one version of the ranking type of machine-learning models, any clusters of any serving containers may serve any number of versions of any number of any types of any machine-learning models.

In some implementations, each of the serving containers 115 registers with service discovery and configuration system 111 by providing the serving container's registration information, such as the host, the port, functions, or similar information. When any of the serving containers 115 is no longer available or becomes unavailable, the discovery and configuration system 111 deletes the unavailable serving container's registration information. An available serving container 115 can be referred to as an actual serving container.

The discovery and configuration system 111 can be implemented by HashiCorp Consul, Apache Zookeeper, Cloud Native Computing Foundation etcd, Netflix eureka, or any similar tool that provides service discovery and/or a service registration system. The discovery and configuration system 111 can track container information about each serving container and model information about each serving container's machine-learning models. In other implementations, this information can be stored in other locations such as datastore 113 using a format or organization. Container information can be data about an isolated execution environment, which executes the main functionality of a machine-learning model. Model information can be data about the algorithms and/or statistical models that perform a specific task effectively by relying on patterns and inference instead of using explicit instructions.

The routing service 103 can be deployed with multiple redundant and/or distributed instances so that it is not a single point of failure for the machine-learning serving infrastructure 100. In some implementations, one instance of the routing service 103 acts as a master, while other instances of the routing service 103 are in a hot standby mode, ready to take over if the master instance of the routing manager 164 fails, or perform some operations at the direction of the master instance.

The routing service 103 makes decisions to load, rebalance, delete, distribute, and replicate machine-learning models in the serving containers 115. These decisions can be based on the information provided to the routing service 103 by the serving containers 115 and other elements of the machine-learning serving infrastructure 100. The data model information in the discovery and configuration system 111 provides information about which serving containers are expected to host-specific machine-learning models and which serving containers actually host the specified machine-learning models. The routing service 103 can also send a list of expected machine-learning models to a model mapping structure in the discovery and configuration system 111. Each of the serving containers 115 can manage a list of executing machine-learning models. If the serving container list does not match the list of expected machine-learning models that a serving container receives, the serving container can load or delete any machine-learning models as needed, and then update its list of executing machine-learning models accordingly. The routing service 103 can monitor and maintain each serving container's list of actual machine-learning models to determine where to route requests.

The routing service 103 can analyze the model information about each machine-learning model to decide whether to replicate frequently used machine-learning models to additional serving containers to prevent overloading the serving containers which are hosting the frequently used machine-learning models. The routing service 103 can use the data model information of the service discovery and configuration system 111 to manage lists of available machine-learning models and available serving containers. Every time a machine-learning model is loaded, the serving container registers the machine-learning model in the data model information. Therefore, the routing service 103 can route requests for a particular machine-learning model to the serving containers.

When any of the executing serving containers 115 in any of the executing clusters of serving containers dies unexpectedly, or gracefully, the serving container's heartbeat to the service discovery and configuration system 111 fails. The machine-learning serving infrastructure 100 removes the data for the failed serving container from its directory, files, or similar data structures in the service discovery and configuration system 111. Based on a review of overall resource usage amongst the serving containers 115, the routing service 103 can respond by rebalancing the serving containers 115 in terms of assigned machine-learning models.

When requests are received by the routing service 103 via the MLS gateway 101, a check of the mapping is made to determine if a requested machine-learning model is executing using the service discovery and configuration system 111. If found, then the routing service 101 can forward the requests (or divide the request into a set of sub-requests) to the identified serving containers 115. If a machine-learning model for the request is not found, then the routing service 101 can load the machine-learning model from a datastore 113, specialized database, or store 107 (e.g., a simple storage service (S3)), or similar location into a selected cluster and serving container.

In some implementations, the machine-learning serving infrastructure 100 can include any number of additional supporting features and functions. These additional supporting features and functions can include application services 161, virtual machine services (VMS) 163, redistribution services, and similar functions and services. The application services 161 can be any number, combination, and variety of functions and services for supporting tenant applications and the machine-learning serving infrastructure 100. The VMS 163 can be any number, combination, and variety of functions and services for supporting virtual machines in the machine-learning serving infrastructure 100. The redistribution services can be any number, combination, and variety of interconnecting services to enable communication between the components of the machine-learning serving infrastructure 100 and supporting components. In some embodiments, serving containers can interface with or support metrics bus clients 165, databus clients 167, and similar components. The metrics bus clients 165 can be services that gather or monitor metrics of the serving containers 115 and similar aspects of the machine-learning service 100. Similarly, the databus clients 167 can be services and functions that enable data communication and access between the serving containers 115 and other components of the machine-learning serving infrastructure 100.

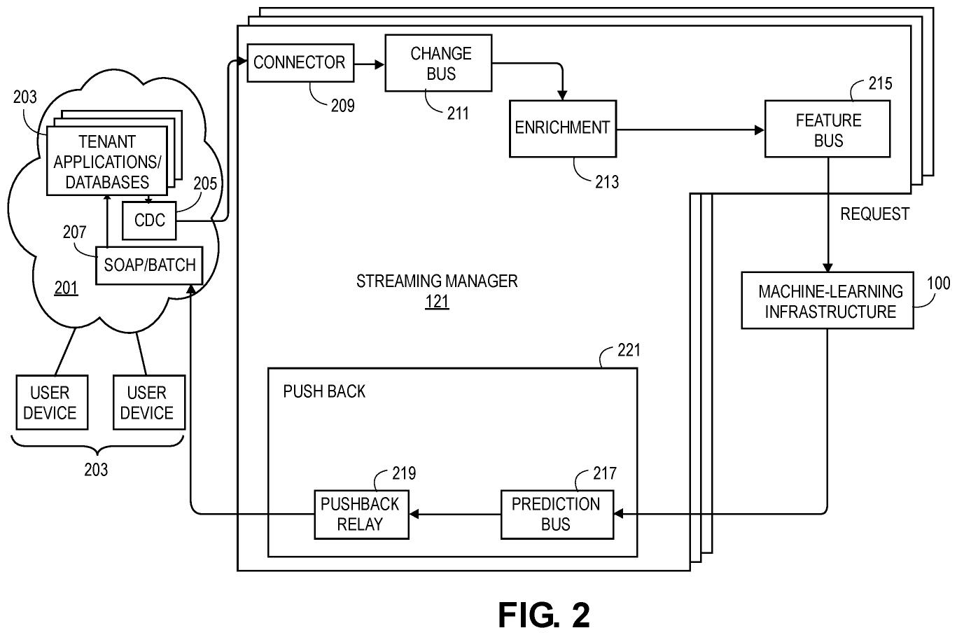

FIG. 2 is a diagram of the streaming manager 121 according to some example implementations. In an example implementation, the machine-learning serving infrastructure 100 is implemented in a cloud computing system and in conjunction with a multi-tenants system 201, that supports a set of user devices or clients 203. Any number, type, combination, or a variety of user devices 201 executing any type of clients can be supported by the multi-tenant system 201. The multi-tenant system 201 can provide any number of tenant applications, databases, and similar resources 203 to the user devices 201 and associated users. These tenant applications and user devices can access the machine-learning serving infrastructure 100 via on-demand requests as described herein. In addition, the streaming manager 121 can enable support for streaming requests with the same machine-learning serving infrastructure 100.

The streaming manager 121 can be instanced with any number of streaming managers supporting the multi-tenant system 201. Each instance can support a different tenant, set of tenants, users, applications, or similar division of work. The streaming manager can receive requests from the tenant applications, users, or similar aspects of the multi-tenant system and initiate monitoring of the associated databases, records, data fields, or related aspects for the data associated with the requests. The streaming manager interfaces with these resources via a change data capture (CDC) interface 205 or similar component of the multi-tenant system 201.

The streaming manager 121 can include a connector 209 to interface or receive updates from the CDC 205. These updates provide information about any creates, reads, updates, and deletes (CRUDs) for data associated with a streaming request. The connector processes these CRUD updates for any data associated with a streaming request. In the example implementations, these updates are processed and stored in or placed on a change bus, which includes the basic relevant information about the changes, rather than full copies of the associated resource. An enrichment component 213 can process these changes and determine whether the changes meet the criteria for generating a new request to the machine-learning serving infrastructure 100. The criteria can be any logic, threshold, or similar mechanism that can be utilized to determine the criteria for generating the request. If the criteria are met, then the enrichment component 213 generates the request and places it in the feature bus 215.

The feature bus 215 is a storage or queue for requests that are ready to be sent and processed by the machine-learning serving infrastructure 100. These requests are sent to the machine-learning serving infrastructure at the speed that the machine-learning serving infrastructure 100 can process them using either push or pull mechanics. In response the machine-learning serving infrastructure 100 can return results (e.g., scoring or similar prediction) to the streaming manager 121, which places the results in a prediction bus 217 or similar structure. The prediction bus 217 is managed and processed by the push back component 221, which includes a push back relay 219 to forward the results to the multi-tenant system 201 by updating the entities in the tenant applications, databases, or related resources 203 to incorporate the results from the machine-learning serving infrastructure 100. The pushback relay 219 can utilize a batch or SOAP interface or protocol for pushing the updates to the multi-tenant system 201 and updating the associated data structure (e.g., entities and objects) therein.

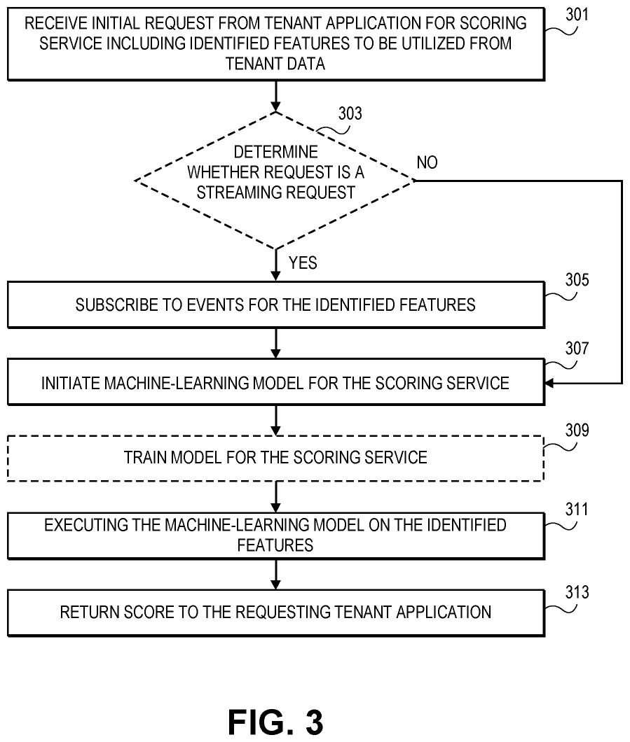

FIG. 3 is a flowchart of one embodiment of a process for a streaming manager according to some implementations. The process of the streaming manager can be responsive to receiving an initial request for a scoring service or similar machine-learning model prediction. The request can identify the machine-learning model (e.g., a scoring service) as well as the features to utilized in generating the prediction (e.g., a score) (Block 301). Any number and combination of features can be identified tied to any number of entities (e.g., any number and combination of data fields of data structures). The combination of features is specific to the tenant resources available to the tenant application that generates the request.

A check can be made in some implementations whether the received request is a streaming request or an on-demand request (Block 303). In other implementations, the streaming manager may only handle streaming requests and does not have to distinguish between the streaming and on-demand requests. If the received request is an on-demand request, then the process can initiate the machine-learning model for the request and prepare the machine-learning model to execute on the identified data (e.g., generate a score based on the identified features) (Block 307). In some implementations, the machine-learning model may be trained or the training updated based on the identified features and/or related information (e.g., for the scoring service) (Block 309). In other implementations, this training is asynchronous to request processing. The features are then applied or processed by the machine-learning model to generate a prediction (e.g., a score) (Block 311). The resulting prediction (e.g., a score) is returned to the requesting tenant application (Block 313).

In cases where the received request is a streaming request, the process subscribes to events for the identified features of the request (Block 305). The subscription can be via any event management system such as an event management system of a multi-tenant system that hosts the tenant application generating the request as well as the tenant data to which the features are associated. For example, if the request identified a set of records in a tenant database as the set of features, then the subscription for events may monitor CRUDs of these features (e.g., changes to records, data fields, data objects, or similar entities). The process can then initiate the machine-learning model for the request and prepare the machine-learning model to execute on the identified data (e.g., generate a score based on the identified features) (Block 307). In some implementations, the machine-learning model may be trained or the training updated based on the identified features and/or related information (e.g., for the scoring service) (Block 309). In other implementations, this training is asynchronous to request processing. The features are then applied or processed by the machine-learning model to generate a prediction (e.g., a score) (Block 311). The resulting prediction (e.g., a score) is returned to the requesting tenant application (Block 313).

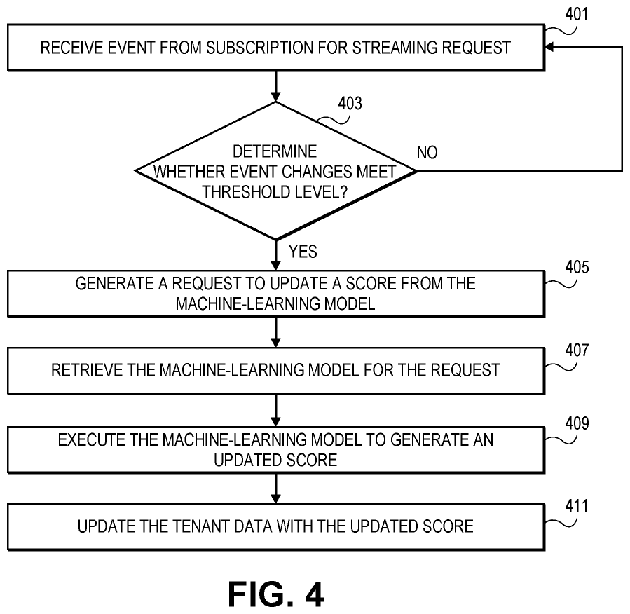

FIG. 4 is a diagram of a process for generating update requests based on event subscriptions according to some implementations. The process of FIG. 4 can be implemented by the streaming manager in connection with the machine-learning serving infrastructure. The streaming manager can continuously receive events based on subscriptions to events where the subscriptions are for monitoring data tenant identified as features of machine-learning models in the machine-learning serving infrastructure. The streaming manager can initiate subscriptions in response to requests for new machine-learning models, based on newly identified features, new tenant requests, or under similar circumstances. Subscriptions can be ended in response to notifications from tenant applications that end the use of identified features, machine-learning models, or related changes.

The process can be triggered by the receipt of an event from the event management system for a subscription tied to a previously received streaming request (Block 401). A check is made whether the received event meets a set of defined criteria tied to the subscription (Block 403). The criteria can define any threshold level, logic, process, or mechanism for triggering an update of a prediction from the associated machine-learning model. The threshold level or similar mechanism can be specific to a machine-learning model, subscription, event or event type, feature, or similar level of granularity. The criteria can be based on the single received event or an accumulation of the same events of that subscription or any combination of events and subscriptions.

The criteria can be specified by an administrator, the associated machine-learning model, the streaming manager, the tenant application, a user, or a similar entity. If the received event does not cause a triggering of the threshold level, then the process continues to monitor or await receipt of further events (Block 401) until the threshold level is met (Block 403). If the threshold level is met, then the streaming manager generates a request to be sent to the machine-learning serving infrastructure via the MLS gateway to update a score or similar prediction from the machine-learning model associated with the event subscription and queues the request for processing by the machine-learning serving infrastructure (Block 405).

The machine-learning serving infrastructure processes the request by retrieving the associated machine-learning model identified in the request (Block 407). The retrieved machine-learning model is then executed on the current state of the tenant data and identified features to generate an updated prediction of the score (Block 409). The updated score is then returned to the streaming manager (Block 411). The streaming manager then updates the associated tenant application data with the updated score or prediction. For example, the updated score or prediction can be used to update the tenant application data, database, or similar resource in the multi-tenant system that hosts the tenant via a batch or SOAP protocol or process.

### Example Electronic Devices and Environments

Electronic Device and Machine-Readable Media

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read-only memory (ROM), Flash memory, phase change memory, solid-state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long-term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals—such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end-user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end-user roles. As an administrator, a user typically uses electronic devices to administer them for other users, and thus an administrator often works directly and/or indirectly with server devices and client devices.

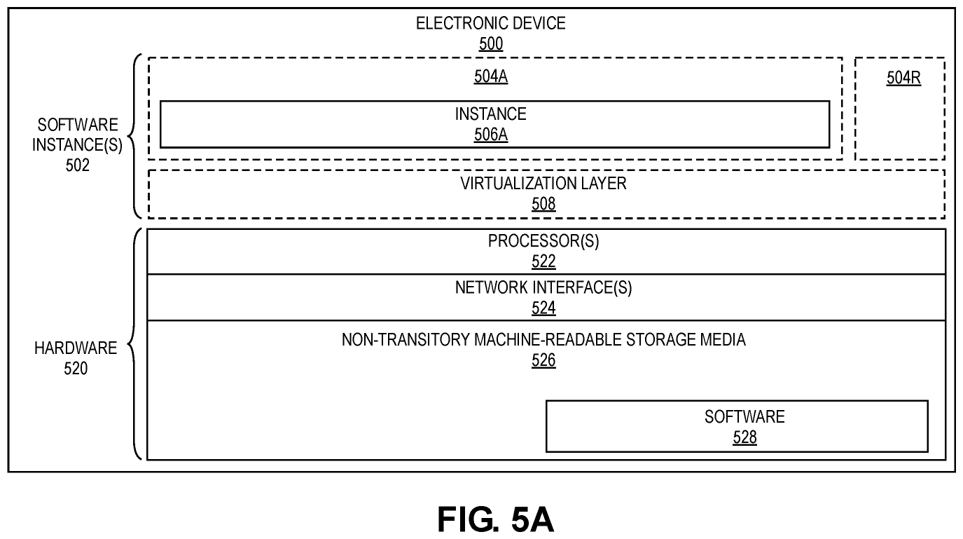

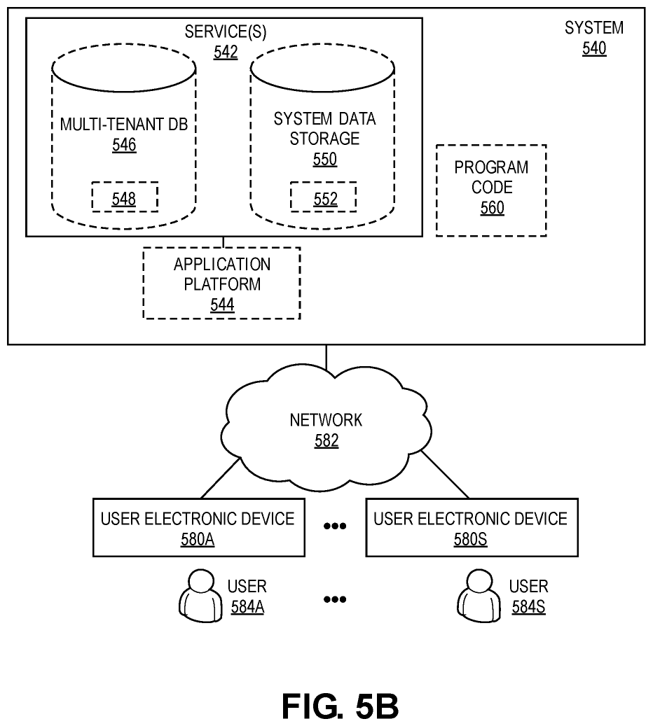

FIG. 5A is a block diagram illustrating an electronic device 500 according to some example implementations. FIG. 5A includes hardware 520 comprising a set of one or more processor(s) 522, a set of one or more network interfaces 524 (wireless and/or wired), and machine-readable media 526 having stored therein software 528 (which includes instructions executable by the set of one or more processor(s) 522). The machine-readable media 326 may include non-transitory and/or transitory machine-readable media. Each of the previously described clients and the streaming manager and machine-learning serving infrastructure may be implemented in one or more electronic devices 500. In one implementation: 1) each of the clients is implemented in a separate one of the electronic devices 500 (e.g., in end user devices where the software 528 represents the software to implement clients to interface directly and/or indirectly with the streaming manager and machine-learning serving infrastructure (e.g., software 528 represents a web browser, a native client, a portal, a command-line interface, and/or an application programming interface (API) based upon protocols such as Simple Object Access Protocol (SOAP), Representational State Transfer (REST), etc.)); 2) the streaming manager and machine-learning serving infrastructure is implemented in a separate set of one or more of the electronic devices 500 (e.g., a set of one or more server devices where the software 528 represents the software to implement the streaming manager and machine-learning serving infrastructure); and 3) in operation, the electronic devices implementing the clients and the streaming manager and machine-learning serving infrastructure would be communicatively coupled (e.g., by a network) and would establish between them (or through one or more other layers and/or or other services) connections for submitting requests to the streaming manager and machine-learning serving infrastructure and returning results to the clients. Other configurations of electronic devices may be used in other implementations (e.g., an implementation in which the client and the streaming manager and machine-learning serving infrastructure are implemented on a single one of electronic device 500).

During operation, an instance of the software 528 (illustrated as instance 506 and referred to as a software instance; and in the more specific case of an application, as an application instance) is executed. In electronic devices that use compute virtualization, the set of one or more processor(s) 522 typically execute software to instantiate a virtualization layer 508 and one or more software container(s) 504A-304R (e.g., with operating system-level virtualization, the virtualization layer 508 may represent a container engine (such as Docker Engine by Docker, Inc., or rkt in Container Linux by Red Hat, Inc.) running on top of (or integrated into) an operating system, and it allows for the creation of multiple software containers 504A-304R (representing separate user space instances and also called virtualization engines, virtual private servers, or jails) that may each be used to execute a set of one or more applications; with full virtualization, the virtualization layer 508 represents a hypervisor (sometimes referred to as a virtual machine monitor (VMM)) or a hypervisor executing on top of a host operating system, and the software containers 504A-304R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 528 is executed within the software container 504A on the virtualization layer 508. In electronic devices where compute virtualization is not used, the instance 506 on top of a host operating system is executed on the “bare metal” electronic device 500. The instantiation of the instance 506, as well as the virtualization layer 508 and software containers 504A-304R if implemented, are collectively referred to as software instance(s) 502.

Alternative implementations of an electronic device may have numerous variations from those described above. For example, customized hardware and/or accelerators might also be used in an electronic device.

### Example Environment

FIG. 5B is a block diagram of a deployment environment according to some example implementations. A system 540 includes hardware (e.g., a set of one or more server devices) and software to provide service(s) 542, including the streaming manager and machine-learning serving infrastructure. In some implementations, the system 540 is in one or more data center(s). These datacenter(s) may be: 1) first-party datacenter(s), which are data center(s) owned and/or operated by the same entity that provides and/or operates some or all of the software that provides the service(s) 542; and/or 2) third-party datacenter(s), which are data center(s) owned and/or operated by one or more different entities than the entity that provides the service(s) 542 (e.g., the different entities may host some or all of the software provided and/or operated by the entity that provides the service(s) 542). For example, third-party data centers may be owned and/or operated by entities providing public cloud services (e.g., Amazon.com, Inc. (Amazon Web Services), Google LLC (Google Cloud Platform), Microsoft Corporation (Azure)).

The system 540 is coupled to user devices 580A-380S over a network 582. The service(s) 542 may be on-demand services that are made available to one or more of the users 584A-384S working for one or more entities other than the entity which owns and/or operates the on-demand services (those users sometimes referred to as outside users) so that those entities need not be concerned with building and/or maintaining a system, but instead may make use of the service(s) 542 when needed (e.g., when needed by the users 584A-384S). The service(s) 542 may communicate with each other and/or with one or more of the user devices 580A-380S via one or more APIs (e.g., a REST API). In some implementations, the user devices 580A-380S are operated by users 584A-384S, and each may be operated as a client device and/or a server device. In some implementations, one or more of the user devices 580A-380S are separate ones of the electronic device 500 or include one or more features of the electronic device 500.

In some implementations, the system 540 is a multi-tenant system (also known as a multi-tenant architecture). The term multi-tenant system refers to a system in which various elements of hardware and/or software of the system may be shared by one or more tenants, along with similar elements as would be understood by those skilled in the art. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant-specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants.

In one implementation, the system 540 is a multi-tenant cloud computing architecture supporting multiple services, such as one or more of the following types of services: Customer relationship management (CRM); Configure, price, quote (CPQ); Business process modeling (BPM); Customer support; Marketing; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Security; and Identity and access management (IAM).

For example, system 540 may include an application platform 544 that enables PAAS for creating, managing, and executing one or more applications developed by the provider of the application platform 544, users accessing the system 540 via one or more of user devices 580A-380S, or third-party application developers accessing the system 540 via one or more of user devices 580A-380S.

In some implementations, one or more of the service(s) 542 may use one or more multi-tenant databases 546, as well as system data storage 550 for system data 552 accessible to system 540. In certain implementations, the system 540 includes a set of one or more servers that are running on server electronic devices and that are configured to handle requests for any authorized user associated with any tenant (there is no server affinity for a user and/or tenant to a specific server). The user devices 580A-380S communicate with the server(s) of system 540 to request and update tenant-level data and system-level data hosted by system 540, and in response, the system 540 (e.g., one or more servers in system 540) automatically may generate one or more Structured Query Language (SQL) statements (e.g., one or more SQL queries) that are designed to access the desired information from the multi-tenant database(s) 546 and/or system data storage 550.

In some implementations, the service(s) 542 are implemented using virtual applications dynamically created at run time responsive to queries from the user devices 580A-380S and in accordance with metadata, including 1) metadata that describes constructs (e.g., forms, reports, workflows, user access privileges, business logic) that are common to multiple tenants; and/or 2) metadata that is tenant-specific and describes tenant-specific constructs (e.g., tables, reports, dashboards, interfaces, etc.) and is stored in a multi-tenant database. To that end, the program code 560 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 544 includes an application setup mechanism that supports application developers' creation and management of applications, which may be saved as metadata by save routines. Invocations to such applications, including the streaming manager and machine-learning serving infrastructure, maybe coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 582 may be anyone or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4^{th} generation wireless protocol (4G) (e.g., the Long Term Evolution (LTE) standard, LTE Advanced, LTE Advanced Pro), a fifth-generation wireless protocol (5G), and/or similar wired and/or wireless protocols, and may include one or more intermediary devices for routing data between the system 540 and the user devices 580A-380S.

Each user device 580A-380S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touchpad, a touch screen, a pen or the like, video or touch-free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 540. For example, the user interface device can be used to access data and applications hosted by system 540, and to perform searches on stored data, and otherwise allow one or more of users 584A-384S to interact with various GUI pages that may be presented to the one or more of users 584A-384S. User devices 580A-380S might communicate with system 540 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 580A-380S might include an HTTP client, commonly referred to as a “browser,” for sending and receiving HTTP messages to and from the server(s) of system 540, thus allowing users 584A-384S of the user devices 580A-380S to access, process and view information, pages, and applications available to it from system 540 over network 582.

### CONCLUSION

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting.

What is claimed is:

1. A method comprising:
receiving a request from a tenant application for a machine-learning serving infrastructure, the request identifying features of tenant data and a machine-learning model;
subscribing to events for the identified features;
initiating the machine-learning model for the request; and
generating a prediction using the machine-learning model on the identified features.

2. The method of claim 1, further comprising:
returning the prediction to the tenant application.

3. The method of claim 1, further comprising:
receiving an event based on the subscription for the machine learning model from an event manager monitoring the tenant data.

4. The method of claim 1, further comprising:
requesting the prediction using the machine-learning model in response to determining that a cumulation of subscribed event changes has met a threshold.

5. The method of claim 4, further comprising:
retrieving the machine-learning model correlating to a received event.

6. The method of claim 1, further comprising:
generating a plurality of requests to send to a plurality of machine-learning models in response to determining that a received event meets criteria for generating an updated prediction.

7. A non-transitory machine-readable storage medium that provides instructions that, if executed by a set of one or more processors, are configurable to cause the set of one or more processors to perform operations comprising:
receiving a request from a tenant application for a machine-learning serving infrastructure, the request identifying features of tenant data and a machine-learning model;
subscribing to events for the identified features;
initiating the machine learning model for the request; and
generating a prediction using the machine learning model on the identified features.

8. The non-transitory machine-readable storage medium of claim 1, where the operations further comprise:
returning the prediction to the tenant application.

9. The non-transitory machine-readable storage medium of claim 1, where the operations further comprise:
receiving an event based on the subscription for the machine learning model from an event manager monitoring the tenant data.

10. The non-transitory machine-readable storage medium of claim 1, where the operations further comprise:
requesting the prediction using the machine learning model in response to determining that a cumulation of subscribed event changes has met a threshold.

11. The non-transitory machine-readable storage medium of claim 10, where the operations further comprise:
retrieving the machine learning model correlating to a received event.

12. The non-transitory machine-readable storage medium of claim 1, where the operations further comprise:
generating a plurality of requests to send to a plurality of machine-learning models in response to determining that a received event meets criteria for generating an updated prediction.

13. An apparatus comprising:
a set of one or more processors;
a non-transitory machine-readable storage medium that provides instructions that, if executed by the set of one or more processors, are configurable to cause the apparatus to perform operations comprising,
receiving a request from a tenant application for a machine-learning serving infrastructure, the request identifying features of tenant data and a machine-learning model;
subscribing to events for the identified features;
initiating the machine learning model for the request; and
generating a prediction using the machine learning model on the identified features.

14. The apparatus of claim 13, where the operations further comprise:
returning the prediction to the tenant application.

15. The apparatus of claim 13, where the operations further comprise:
receiving an event based on the subscription for the machine learning model from an event manager monitoring the tenant data.

16. The apparatus of claim 13, where the operations further comprise:
requesting the prediction using the machine learning model in response to determining that a cumulation of subscribed event changes has met a threshold.

17. The apparatus of claim 16, where the operations further comprise:
retrieving the machine learning model correlating to a received event.

18. The apparatus of claim 13, where the operations further comprise:
generating a plurality of requests to send to a plurality of machine-learning models in response to determining that a received event meets criteria for generating an updated prediction.
